(19) United States
(12) Patent Application Publication
(10) Pub. No.: US 2009/0000063 A1
(43) Pub. Date: Jan. 1, 2009

(54) Guard for vehicle door handles and keyholes

(76) Inventor: Leandres Self, Greensburg, LA (US)

Correspondence Address: JAMES RAY & ASSOCIATES, 2640 PITCAIRN ROAD, MONROEVILLE, PA, 15146, US

(21) Appl. No.: 12/215,078

(22) Filed: Jun. 25, 2008

Related U.S. Application Data
(60) Provisional application No. 60/947,193, filed on Jun. 29, 2007.

(51) Int. Cl. E05B 17/14

(52) U.S. Cl. 16/402

(57) ABSTRACT

An apparatus for protecting a vehicle door handle, a keyhole and an area immediately surrounding such door handle. The apparatus comprises a guard member having each of a predetermined shape, a predetermined thickness and a predetermined color and formed of a predetermined material. The guard member is for engagement with one of such predetermined area around such door handle of such vehicle and such keyhole. An adhesive is disposed on an underside of the guard member for affixing the guard member to one of such predetermined area around such door handle of such vehicle and to such keyhole. A backing member is engageable with the adhesive disposed on the guard member for preventing the adhesive from sticking to other objects until ready for use.

### CROSS REFERENCE TO RELATED APPLICATIONS

This application is closely related to and claims benefit from U.S. Provisional Application Ser. No. 60,947,193 filed Jun. 29, 2007.

### FIELD OF THE INVENTION

The present invention relates, in general, to a device for a vehicle, and, more particularly the present invention relates to a device for mounting on an automobile or other vehicle around the key entry to prevent scratches to the exterior paint of the car door.

### BACKGROUND OF THE INVENTION

Entering a new car or truck can often result in scratches under or around the exterior door handle. The paint can become worn, faded, chipped and scratched due to keys, fingernails or rings that accidentally scrape the paint. These blemishes cause the automobile to look bad and over time, can lead to rust. These scratches can also be seen around the keyhole. Applying and reapplying touch up paint can be expensive and finding an exact color match can be difficult. The new vehicle can lose it's new car look and feel in short order when these blemishes occur.

Thus, it would be advantageous if there were a simple and effective means of preventing such scratches from occurring rather than trying to correct them after they have occurred.

### SUMMARY OF THE INVENTION

In a first aspect the present invention there is provided an apparatus for protecting a vehicle door handle, a keyhole and an area immediately surrounding such door handle. The apparatus comprises a guard member having each of a predetermined shape, a predetermined thickness and a predetermined color and formed of a predetermined material. The guard member is for engagement with one of such predetermined area around such door handle of such vehicle and such keyhole. An adhesive is disposed on an underside of the guard member for affixing the guard member to one of such predetermined area around such door handle of such vehicle and to such keyhole. A backing member is engageable with the adhesive disposed on the guard member for preventing the adhesive from sticking to other objects until ready for use.

In a second aspect the present invention there is provided an apparatus for protecting a vehicle door handle and an area immediately surrounding such door handle. The apparatus comprises a guard member having each of a predetermined shape, a predetermined thickness and a predetermined color and formed of a predetermined material. The guard member engages such predetermined area around such door handle of such vehicle. An adhesive is disposed on an underside of the guard member for affixing the guard member to such predetermined area around such door handle of such vehicle. A backing member is engageable with the adhesive disposed on the guard member for preventing the adhesive from sticking to other objects until ready for use.

In a third aspect the present invention provides an apparatus for protecting a keyhole in a door of a vehicle and an area immediately surrounding such keyhole. The apparatus comprises a guard member having each of a predetermined shape, a predetermined thickness and a predetermined color and formed of a predetermined material. The guard member engages such keyhole an such area immediately surrounding such keyhole of such vehicle. An adhesive is disposed on an underside of the guard member for affixing the guard member to such keyhole and such area immediately surrounding such keyhole of such vehicle. A backing member engages such adhesive disposed on the guard member for preventing the adhesive from sticking to other objects until ready for use.

### OBJECTS OF THE INVENTION

It is, therefore, one of the primary objects of the present invention to provide an apparatus for preventing scratches around the door handle of a vehicle.

Another object of the present invention is to provide an apparatus for preventing scratches around the keyhole of a vehicle.

Still another object of the present invention is to provide an apparatus for preventing scratches that is made of plastic.

Yet another object of the present invention is to provide an apparatus for preventing scratches that is easy to install.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a perspective view of a circular guard member for protecting area around a keyhole.

FIG. 2 is perspective view of an oval shaped guard member that has a checkered pattern.

FIG. 3 is a perspective view of an oval shaped guard member showing the adhesive and the backing member.

FIG. 4 is a perspective view of circular guard member being being placed over the keyhole to protect the area around such keyhole.

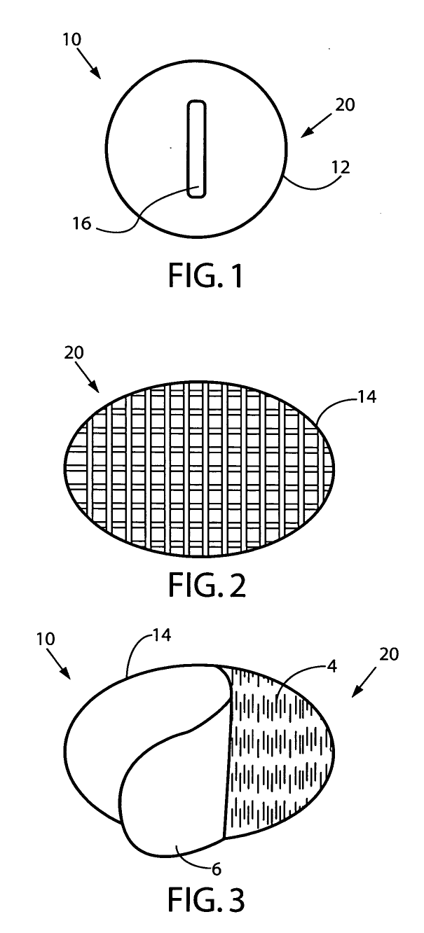

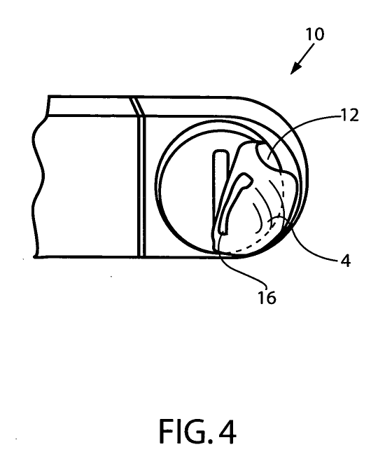

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for protecting a vehicle door handle, a keyhole and an area immediately surrounding such door handle. The apparatus comprises a guard member, generally designated 20, having each of a predetermined shape, a predetermined thickness and a predetermined color and formed of a predetermined material. The guard member 20 is for engagement with one of such predetermined area around such door handle of such vehicle and such keyhole. An adhesive 4 is disposed on an underside of the guard member 20 for affixing the guard member 20 to one of such predetermined area around such door handle of such vehicle and to such keyhole. A backing member 6 is engageable with the adhesive 4 disposed on the guard member 20 for preventing the adhesive 4 from sticking to other objects until ready for use.

Such predetermined shape of the guard member is one of a circular piece 12 and an oval strip 14. It is presently preferred that the backing member 6 is paper.

The oval strip 14 is placed beneath such door handle of such vehicle to prevent scratches thereto when a user opens such door of such vehicle. The oval strip 14 is positioned in the area under the door handle so that sharp fingernails, rings or other such items that might be on the fingers of the user do not engage the car's paint but come into contact with the oval 14 shaped guard member instead.

Similarly, a circular piece 12 is used to cover such keyhole so as to prevent scratches thereto when such user places a key in such keyhole. Since it is not always easy to find the keyhole, particularly at night, the area around the keyhole is very susceptible to scratches as the user fumbles with the key trying to find the keyhole. Such circular piece 12 used to cover such keyhole has a slit 16 disposed therein for providing access to a key.

It is presently preferred that such predetermined color of such guard member 20 is one of chrome, clear and a variety of colors to match an exterior paint color of such vehicle. It is also within the concept of the invention that such variety of colors includes a checkered pattern.

Although there are individual colors that can match the color of the vehicle so as to be unobtrusive such clear color or such chrome color could be used on any color of such vehicle. It is presently preferred that such guard member 20 be made of plastic and that such plastic is a vinyl.

The predetermined shape of the guard member 20 is one of a circular piece 12 and an oval strip 14. Such oval strip 14 is placed beneath such door handle of such vehicle to prevent scratches thereto when a user opens such door of such vehicle and the circular piece 12 is used to cover such keyhole so as to prevent scratches thereto when such user places a key in such keyhole. The circular piece 12 used to cover such keyhole has a slit 16 disposed therein for providing access to a key. Also it is presently preferred that such backing member 6 is paper and also is it preferred that such guard member 20 is made of plastic and that such plastic is vinyl.

In a second aspect the present invention provides an apparatus 10 for protecting a vehicle door handle and an area immediately surrounding such door handle. The apparatus 10 comprises a guard member 20 having each of a predetermined shape, a predetermined thickness and a predetermined color and formed of a predetermined material. The guard member 20 having an oval shape 14 engages such predetermined area around such door handle of such vehicle. An adhesive 4 is disposed on an underside of the guard member 20 for affixing the guard member to such predetermined area around such door handle of such vehicle. A backing member 6 is engageable with the adhesive 4 disposed on the guard member 20 for preventing the adhesive 4 from sticking to other objects until ready for use.

In a third aspect the present invention provides an apparatus 10 for protecting a keyhole in a door of a vehicle and an area immediately surrounding such keyhole. The apparatus 10 comprises a guard member 20 having each of a predetermined shape, a predetermined thickness and a predetermined color and formed of a predetermined material. The guard member 20, having a circular 12 shape engages such keyhole and such area immediately surrounding such keyhole of such vehicle. An adhesive 4 is disposed on an underside of the circular 12 shaped guard member for affixing the guard member 20 to such keyhole and such area immediately surrounding such keyhole of such vehicle. A backing member 6 engages such adhesive disposed on the guard member for preventing the adhesive from sticking to other objects until ready for use.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for protecting a vehicle door handle and an area immediately surrounding such door handle, said apparatus comprising:
(a) a guard member having each of a predetermined shape, a predetermined thickness and a predetermined color and formed of a predetermined material, said guard member for engagement with one of such predetermined area around such door handle of such vehicle and a keyhole;
(b) an adhesive disposed on an underside of said guard member for affixing said guard member to said one of such predetermined area around such door handle of such vehicle and such keyhole; and
(c) a backing member engageable with said adhesive disposed on said guard member for preventing said adhesive from sticking to other objects until ready for use.

2. The apparatus, according to claim 1, wherein said predetermined shape of said guard member is one of a circular piece and an oval strip.

3. The apparatus, according to claim 1, wherein said backing member is paper.

4. The apparatus, according to claim 2, wherein said oval strip is placed beneath such door handle of such vehicle to prevent scratches thereto when a user opens such door of such vehicle.

5. The apparatus, according to claim 2, wherein said circular piece is used to cover such keyhole so as to prevent scratches thereto when such user places a key in such keyhole.

6. The apparatus, according to claim 5, wherein said circular piece used to cover such keyhole has a slit disposed therein for providing access to a key.

7. The apparatus, according to claim 1, wherein said predetermined color of said guard member is one of chrome, clear and a variety of colors to match an exterior paint color of such vehicle.

8. The apparatus, according to claim 7, wherein said variety of colors further includes a checkered pattern.

9. The apparatus, according to claim 7, wherein said guard member having a clear color can be used on any color of such vehicle.

10. The apparatus, according to claim 7, wherein said guard member having a chrome color can be used on any color of such vehicle.

11. The apparatus, according to claim 1, wherein said predetermined material of said guard member is plastic.

12. The apparatus, according to claim 10, wherein said plastic is vinyl.

13. An apparatus for protecting a vehicle door handle and an area immediately surrounding such door handle, said apparatus comprising:
(a) a guard member having each of a predetermined shape, a predetermined thickness and a predetermined color and formed of a predetermined material, said guard member for engagement with such predetermined area around such door handle of such vehicle;
(b) an adhesive disposed on an underside of said guard member for affixing said guard member to said one of such predetermined area around such door handle of such vehicle; and
(c) a backing member engageable with said adhesive disposed on said guard member for preventing said adhesive from sticking to other objects until ready for use.

14. The apparatus, according to claim 13, wherein said predetermined shape of said guard member is an oval strip.

15. The apparatus, according to claim 1, wherein said backing member is paper.

16. The apparatus, according to claim 14, wherein said oval strip is placed beneath such door handle of such vehicle to prevent scratches thereto when a user opens such door of such vehicle.

17. The apparatus, according to claim 13, wherein said predetermined color of said guard member is one of chrome, clear and a variety of colors to match an exterior paint color of such vehicle.

18. An apparatus for protecting a keyhole in a door of a vehicle and an area immediately surrounding such keyhole, said apparatus comprising:
(a) a guard member having each of a predetermined shape, a predetermined thickness and a predetermined color and formed of a predetermined material, said guard member for engagement with such keyhole an said area immediately surrounding such keyhole of such vehicle;
(b) an adhesive disposed on an underside of said guard member for affixing said guard member to such keyhole and such area immediately surrounding such keyhole of such vehicle; and
(c) a backing member engageable with said adhesive disposed on said guard member for preventing said adhesive from sticking to other objects until ready for use.

19. The apparatus, according to claim 18, wherein said predetermined shape of said guard member is circular.

20. The apparatus, according to claim 18, wherein said circular guard member used to cover such keyhole has a slit disposed therein for providing access to a key.
